(19) United States
(12) Patent Application Publication
(10) Pub. No.: US 2022/0351046 A1
(43) Pub. Date: Nov. 3, 2022

(54) GENERALIZED DATA GENERATION DEVICE, ESTIMATION DEVICE, GENERALIZED DATA GENERATION METHOD, ESTIMATION METHOD GENERALIZED DATA GENERATION PROGRAM, AND ESTIMATION PROGRAM

(71) Applicant: NIPPON TELEGRAPH AND TELEPHONE CORPORATION, Tokyo (JP)

(72) Inventors: Yuki KURAUCHI, Tokyo (JP); Naoto ABE, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/619,602

(22) PCT Filed: Jun. 18, 2019
(86) PCT No.: PCT/JP2019/024121

§ 371 Date: Dec. 16, 2021

(51) Int. Cl. G06N 3/08

(52) U.S. Cl. CPC G06N 3/088

(57) ABSTRACT

A generalized data generation device and estimation device, a generalized data generation method and estimation method, and a generalized data generation program and estimation program are provided, which are capable of estimating the state of a target object accurately with the amount of training data being reduced. The generalized data generation device 10 includes: a training unit 101 that trains a generalized model for training 141 for obtaining data satisfying a general parameter through predetermined machine learning by using a general training dataset 142 as input, which is a set of data satisfying the general parameter from among multiple types of parameters, and outputs a trained generalized model 143; and a generalized data generation unit 102 that generates a generalized input dataset 145 generalized by using an input dataset 144, which is a set of data satisfying any of the multiple types of parameters, and the trained generalized model 143, such that the input dataset 144 satisfies the general parameter.

### TECHNICAL FIELD

The technology disclosed herein relates to a generalized data generation device and estimation device, a generalized data generation method and estimation method, and a generalized data generation program and estimation program.

### BACKGROUND ART

Investigation is underway into technologies that use sensors installed on a moving body such as an automobile, a pedestrian, or a wheelchair that moves over a road surface such as a walkway or a roadway to estimate the conditions (such as a level difference or gradient) of the road surface on which the moving body moves (for example, see Non-Patent Literature 1 and 2).

### CITATION LIST

### Non-Patent Literature

Non-Patent Literature 1: Akihiro Miyata, Iori Araki, Tongshun Wang, and Tenshi Suzuki, “A Study on Barrier Detection Using Sensor Data of Unimpaired Walkers”, IPSJ Journal (2018), Internet <URL: https://mytlab.org/wp/wp-content/uploads/2018/05/2017 araki.pdf>

Non-Patent Literature 2: “Experiment to detect and inspect uneven road surface using acceleration sensor of smartphone onboard expressway bus” (in Japanese), [Online], Internet <URL: https://sgforum.impress.co.jp/news/3595>

### SUMMARY OF THE INVENTION

### Technical Problem

Estimating the conditions of a road surface as described above is often performed using a trained model that has been constructed by machine learning using training data. However, in the case where the conditions of the road surface are not uniform, training data for the same road surface as the road surface in the data for which the estimation of the road surface conditions is desired becomes necessary, and the amount of training data becomes necessary, which is problematic. In other words, if the desired data to estimate is a smooth road surface for example, training data for a smooth road surface is necessary, and if the desired data to estimate is a rough road surface for example, training data for a rough road surface is necessary. Data with various parameters is input into the trained model, and therefore to make an accurate estimation, training data for each of these smooth road surface and rough road surface is necessary, and the amount of training data increases.

The technology disclosed herein has been devised in light of the above points, and an object thereof is to provide a generalized data generation device and estimation device, a generalized data generation method and estimation method, and a generalized data generation program and estimation program capable of estimating the state of a target object accurately with the amount of training data being reduced.

### Means for Solving the Problem

To achieve the above object, a generalized data generation device according to a first aspect of the present disclosure includes: a training unit that trains a generalized model for training for obtaining data satisfying a general parameter through predetermined machine learning by using a general training dataset as input, the general training dataset being a set of data satisfying the general parameter from among multiple types of parameters, and outputs a trained generalized model; and a generalized data generation unit that generates a generalized input dataset generalized by using an input dataset, the input dataset being a set of data satisfying any of the multiple types of parameters, and the trained generalized model, such that the input dataset satisfies the general parameter.

Also, an estimation device according to a second aspect of the present disclosure includes: a training unit that trains a state estimation model for training for estimating the state of a target object through predetermined machine learning by using a general training dataset as input, the general training dataset being a set of data satisfying a general parameter from among multiple types of parameters, and outputs a trained state estimation model; and an estimation unit that estimates the state of the target object by using a generalized input dataset and the trained state estimation model, the generalized input dataset being generalized by using an input dataset, the input dataset being a set of data satisfying any of the multiple types of parameters, and a trained generalized model obtained by performing machine learning on the general training dataset, such that the input dataset satisfies the general parameter.

Furthermore, to achieve the above object, a generalized data generation method according to a third aspect of the present disclosure includes: by a training unit, training a generalized model for training for obtaining data satisfying a general parameter through predetermined machine learning by using a general training dataset as input, the general training dataset being a set of data satisfying the general parameter from among multiple types of parameters, and outputting a trained generalized model; and by a generalized data generation unit, generating a generalized input dataset generalized by using an input dataset, the input dataset being a set of data satisfying any of the multiple types of parameters, and the trained generalized model, such that the input dataset satisfies the general parameter.

Also, an estimation method according to a fourth aspect of the present disclosure includes: by a training unit, training a state estimation model for training for estimating the state of a target object through predetermined machine learning by using a general training dataset as input, the general training dataset being a set of data satisfying a general parameter from among multiple types of parameters, and outputting a trained state estimation model; and by an estimation unit, estimating the state of the target object by using a generalized input dataset and the trained state estimation model, the generalized input dataset being generalized by using an input dataset, the input dataset being a set of data satisfying any of the multiple types of parameters, and a trained generalized model obtained by performing machine learning on the general training dataset, such that the input dataset satisfies the general parameter.

Furthermore, to achieve the above object, a generalized data generation program according to a fifth aspect of the present disclosure causes a computer to execute: training a generalized model for training for obtaining data satisfying a general parameter through predetermined machine learning by using a general training dataset as input, the general training dataset being a set of data satisfying the general parameter from among multiple types of parameters, and outputting a trained generalized model, and generating a generalized input dataset generalized by using an input dataset, the input dataset being a set of data satisfying any of the multiple types of parameters, and the trained generalized model, such that the input dataset satisfies the general parameter.

Also, an estimation program according to a sixth aspect of the present disclosure causes a computer to execute: training a state estimation model for training for estimating the state of a target object through predetermined machine learning by using a general training dataset as input, the general training dataset being a set of data satisfying a general parameter from among multiple types of parameters, and outputting a trained state estimation model, and estimating the state of the target object by using a generalized input dataset and the trained state estimation model, the generalized input dataset being generalized by using an input dataset, the input dataset being a set of data satisfying any of the multiple types of parameters, and a trained generalized model obtained by performing machine learning on the general training dataset, such that the input dataset satisfies the general parameter.

### Effects of the Invention

According to the technology disclosed herein, the state of a target object can be estimated accurately with the amount of training data being reduced.

### BRIEF DESCRIPTION OF DRAWINGS

FIG. 1 is a block diagram illustrating an example of a hardware configuration of a generalized data generation device according to an embodiment.

FIG. 2 is a block diagram illustrating an example of a functional configuration of the generalized data generation device according to an embodiment.

FIG. 3 is a flowchart illustrating an example of a flow of processes by a generalized data generation program according to an embodiment.

FIG. 4 is a block diagram illustrating an example of a hardware configuration of an estimation device according to an embodiment.

FIG. 5 is a block diagram illustrating an example of a functional configuration of an estimation device according to an embodiment.

FIG. 6 is a flowchart illustrating an example of a flow of processes by an estimation program according to an embodiment.

FIG. 7 is a diagram accompanying a description of an estimation process using a trained generalized model and a trained state estimation model according to an embodiment.

### DESCRIPTION OF EMBODIMENTS

Hereinafter, an exemplary embodiment of the technology disclosed herein will be described with reference to the drawings. Note that in each of the drawings, the same or equivalent structural elements and portions are denoted with the same reference signs. Also, the dimensional ratios in the drawings are exaggerated for convenience of explanation, and may differ from the actual ratios in some cases.

The present embodiment describes a case in which machine learning is performed using training data generated from road surface data expressing the state of a road surface on which a moving body such as an automobile, a pedestrian, or a wheelchair moves, the road surface data being detected by a sensor installed on the moving body that moves over the road surface. However, the target object is not limited to a road surface, and may be another physical object having a general state and a special state. Note that as an example, sensors such as an acceleration sensor, a gyro sensor, and a gravity sensor are used as the sensor installed on the moving body. Also, the road surface data contains detection values from a sensor during a period in which the moving body moves over the road surface, and is expressed as time series data.

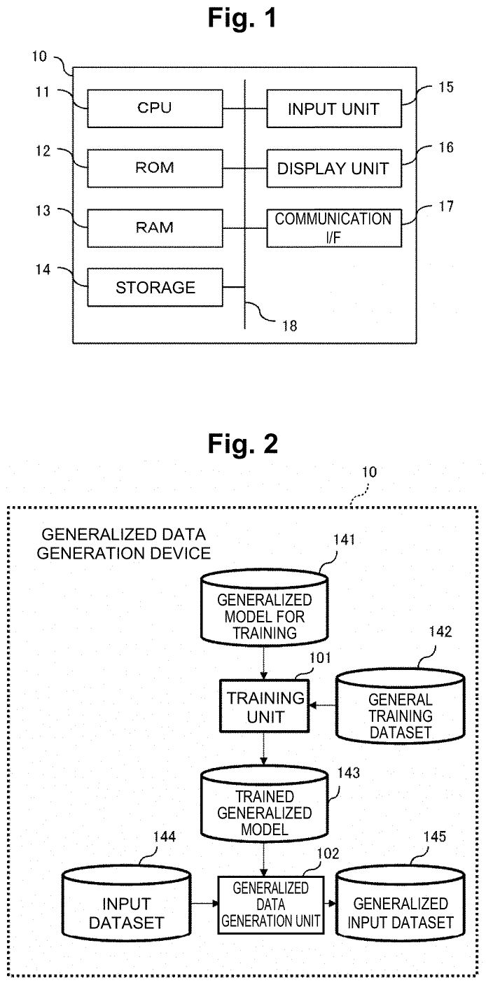

FIG. 1 is a block diagram illustrating an example of a hardware configuration of a generalized data generation device 10 according to the present embodiment.

As illustrated in FIG. 1, the generalized data generation device 10 is provided with a central processing unit (CPU) 11, read-only memory (ROM) 12, random access memory (RAM) 13, storage 14, an input unit 15, a display unit 16, and a communication interface (I/F) 17. The components are communicably interconnected through a bus 18.

The CPU 11 is a central processing unit that executes various programs and controls each component. In other words, the CPU 11 reads out a program from the ROM 12 or the storage 14, and executes the program by using the RAM 13 as a work area. The CPU 11 controls each of the above components and performs various computational processes by following a program stored in the ROM 12 or the storage 14. In the present embodiment, a generalized data generation program is stored in the ROM 12 or the storage 14.

The ROM 12 stores various programs and various data. The RAM 13 stores programs or data temporarily as a work area. The storage 14 includes a hard disk drive (HDD) or a solid-state drive (SSD), and stores various programs and various data including an operating system.

The input unit 15 is used to provide various types of input to the device itself.

The display unit 16 is a liquid crystal display, for example, and displays various information. The display unit 16 may also adopt a touch panel configuration and function as the input unit 15.

The communication interface 17 is an interface by which the device communicates with other external equipment, and a standard such as Ethernet(R), Fiber Distributed Data Interface (FDDI), or Wi-Fi(R) is used, for example.

Next, FIG. 2 will be referenced to describe a functional configuration of the generalized data generation device 10.

FIG. 2 is a block diagram illustrating an example of a functional configuration of the generalized data generation device 10 according to the present embodiment.

As illustrated in FIG. 2, the generalized data generation device 10 is provided with a training unit 101 and a generalized data generation unit 102 as a functional configuration. Each functional component is achieved by causing the CPU 11 to read out and load a generalized data generation program stored in the ROM 12 or the storage 14 into the RAM 13, and execute the program.

The training unit 101 trains a generalized model for training 141 for obtaining data satisfying a general parameter through predetermined machine learning by using a general training dataset 142 as input, which is a set of data satisfying the general parameter from among multiple types of parameters, and outputs a trained generalized model 143.

The generalized data generation unit 102 generates a generalized input dataset 145 generalized by using an input dataset 144, which is a set of data satisfying any of the multiple types of parameters, and the trained generalized model 143, such that the input dataset 144 satisfies the general parameter.

Specifically, the multiple types of parameters described above are parameters such as a smooth road surface and a rough road surface, for example. The data satisfying a general parameter forming the general training dataset 142 is road surface data expressing a smooth road surface, for example. In this case, a collection parameter label may not be assigned to the road surface data. The collection parameter referred to herein is a parameter indicating a road surface such as a smooth road surface or a rough road surface, for example. In the road surface data, ground-truth labels indicating the state of the road surface are applied individually to predetermined intervals. The state of the road surface referred to herein means any of a state in which the road surface is flat, a state in which the road surface has a level difference, and a state in which the road surface is inclined. The ground-truth labels are applied manually, for example. Also, in the generalized model for training 141, any of various models such as a model using a convolutional neural network or a support vector machine (SVM) is used as an example of the machine learning model. In this case, the generalized model for training 141 is a model for obtaining road surface data expressing a smooth road surface, and is trained by machine learning using the general training dataset 142 to generate the trained generalized model 143. In other words, the trained generalized model 143 is a model obtained by machine learning using the road surface data expressing a smooth road surface directly without alteration. The trained generalized model 143 is a model obtained by machine learning as an autoencoder that compresses and reconstructs road surface data expressing a smooth road surface. To generate the trained generalized model 143, a joint multimodal variation autoencoder (JMVAE) may be used as an example of the autoencoder.

Also, the input dataset 144 includes road surface data with various parameters, such as road surface data expressing a rough road surface, road surface data expressing a smooth road surface, and road surface data having other parameters. Note that the determination of a rough road surface and a smooth road surface is made on the basis of detection values from sensors, for example. Generally, detection values from sensors in the case where a moving body travels over a rough road surface vary greatly compared to detection values from sensors in the case where a moving body travels over a smooth road surface. In other words, during periods in which the moving body travels over a smooth road surface, the variation in the road surface data is small, whereas during periods in which the moving body travels over a rough road surface, the variation in the road surface data is large. Consequently, if the variation in the road surface data is a predetermined value or higher, the data is determined to be road surface data expressing a rough road surface, whereas if the variation in the road surface data is less than the predetermined value, the data is determined to be road surface data expressing a smooth road surface.

In the case of acquiring road surface data expressing a rough road surface for example from the input dataset 144, generalized data generation unit 102 uses the trained generalized model 143 to convert the acquired road surface data expressing a rough road surface into road surface data expressing a smooth road surface. The set of converted road surface data expressing a smooth road surface is generated as the generalized input dataset 145. In other words, in the case of acquiring road surface data other than road surface data expressing a smooth road surface, the generalized data generation unit 102 converts the acquired road surface data so as to approach road surface data expressing a smooth road surface forming the trained generalized model 143.

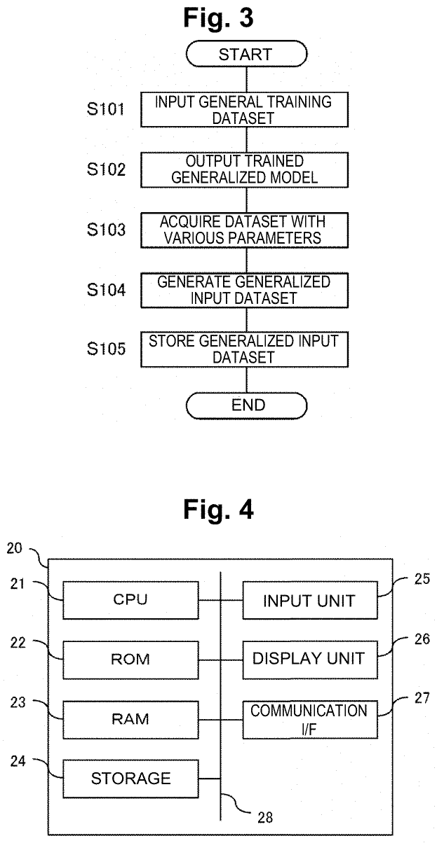

Next, FIG. 3 will be referenced to describe the action of the generalized data generation device 10 according to the present embodiment.

FIG. 3 is a flowchart illustrating an example of a flow of processes by the generalized data generation program according to the present embodiment. The processes by the generalized data generation program are achieved by causing the CPU 11 of the generalized data generation device 10 to write the generalized data generation program stored in the ROM 12 or the storage 14 to the RAM 13 and execute the program.

In step 5101 of FIG. 3, the CPU 11 acts as the training unit 101 to receive the input of the general training dataset 142, which is a set of road surface data expressing a smooth road surface.

In step S102, the CPU 11 acts as the training unit 101 to use the general training dataset 142 received as input in step S101 to perform machine learning and obtain the generalized model for training 141 for obtaining road surface data expressing a smooth road surface, and thereby outputs the trained generalized model 143. As described above, the trained generalized model 143 is a model obtained by machine learning as an autoencoder that compresses and reconstructs road surface data expressing a smooth road surface.

In step S103, the CPU 11 acts as the generalized data generation unit 102 to acquire the input dataset 144, which is a dataset with various parameters.

In step S104, the CPU 11 acts as the generalized data generation unit 102 to use the input dataset 144 and the trained generalized model 143 to generate the generalized input dataset 145 in which each piece of road surface data in the input dataset 144 is generalized into road surface data expressing a smooth road surface.

In step S105, the CPU 11 acts as the generalized data generation unit 102 to store the generalized input dataset 145 generated in step S104 in the storage 14, and then ends the series of processes according to the generalized data generation program.

Next, an embodiment of an estimation device will be described. An estimation device according to the present embodiment is treated as separate from the generalized data generation device described above, but may also be integrated with the generalized data generation device.

FIG. 4 is a block diagram illustrating an example of a hardware configuration of an estimation device 20 according to the present embodiment.

As illustrated in FIG. 4, the estimation device 20 is provided with a CPU 21, ROM 22, RAM 23, storage 24, an input unit 25, a display unit 26, and a communication interface (I/F) 27. The components are communicably interconnected through a bus 28.

The CPU 21 is a central processing unit that executes various programs and controls each component. In other words, the CPU 21 reads out a program from the ROM 22 or the storage 24, and executes the program by using the RAM 23 as a work area. The CPU 21 controls each of the above components and performs various computational processes by following a program stored in the ROM 22 or the storage 24. In the present embodiment, an estimation program is stored in the ROM 22 or the storage 24.

The ROM 22 stores various programs and various data. The RAM 23 stores programs or data temporarily as a work area. The storage 24 includes an HDD or an SSD, and stores various programs and various data including an operating system.

The input unit 25 is used to provide various types of input to the device itself.

The display unit 26 is a liquid crystal display, for example, and displays various information. The display unit 26 may also adopt a touch panel configuration and function as the input unit 25.

The communication interface 27 is an interface by which the device communicates with other external equipment, and a standard such as Ethernet(R), FDDI, or Wi-Fi(R) is used, for example.

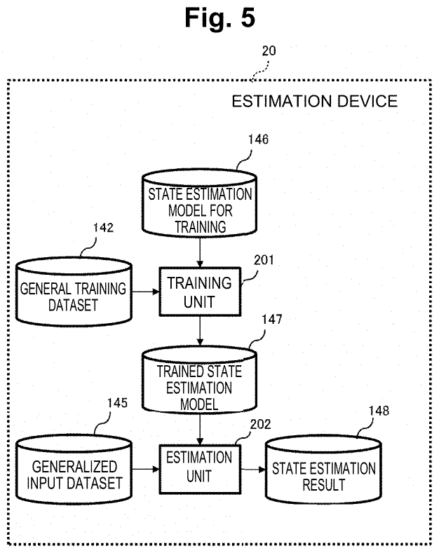

Next, FIG. 5 will be referenced to describe a functional configuration of the estimation device 20.

FIG. 5 is a block diagram illustrating an example of a functional configuration of the estimation device 20 according to the present embodiment.

As illustrated in FIG. 5, the estimation device 20 is provided with a training unit 201 and an estimation unit 202 as a functional configuration. Each functional component is achieved by causing the CPU 21 to read out and load an estimation program stored in the ROM 22 or the storage 24 into the RAM 23, and execute the program.

The training unit 201 trains a state estimation model for training 146 for estimating the state of a target object through predetermined machine learning by using a general training dataset 142 as input, which is a set of data satisfying a general parameter from among multiple types of parameters, and outputs a trained state estimation model 147. Note that the general training dataset 142 is the same as the one used by the generalized data generation device 10 described above.

The estimation unit 202 estimates the state of a target object using the generalized input dataset 145 generated by the generalized data generation device 10 described above and the trained state estimation model 147, and outputs a state estimation result 148 obtained by the estimation. However, the generalized input dataset 145 is a set of data generalized using the input dataset 144 (FIG. 2) and the trained generalized model 143 (FIG. 2) such that the input dataset 144 satisfies a general parameter. The input dataset 144 is a set of data satisfying one of multiple types of parameters. The trained generalized model 143 is a model obtained by performing machine learning on the general training dataset 142.

As described above, the target object is a road surface, for example. The data satisfying a general parameter forming the general training dataset 142 is road surface data expressing a smooth road surface, for example, and in the road surface data, ground-truth labels indicating the state of the road surface are applied individually to predetermined intervals. The state of the road surface referred to herein means any of a state in which the road surface is flat, a state in which the road surface has a level difference, and a state in which the road surface is inclined. Also, in the state estimation model for training 146, any of various models such as a model using a convolutional neural network or an SVM is used as an example of the machine learning model. In this case, the state estimation model for training 146 is a model for estimating the state of the road surface, and is trained by machine learning using the general training dataset 142 to generate the trained state estimation model 147. In other words, the trained state estimation model 147 is a model obtained by performing machine learning using the set of road surface data expressing a smooth road surface forming the general training dataset 142.

On the other hand, the generalized input dataset 145 described above is a set of data obtained by converting the road surface data with various parameters included in the input dataset 144 (for example, a smooth road surface, a rough road surface, and road surfaces with other parameters) into road surface data expressing a smooth road surface. In other words, the road surface data input into the estimation device 20 is road surface data expressing a smooth road surface obtained by converting road surface data with various parameters. Consequently, it is possible to estimate the state of the road surface with respect to the input dataset 144 which is a set of road surface data with various parameters, even with only the trained state estimation model 147 obtained by performing machine learning using road surface data expressing a smooth road surface.

In other words, the estimation unit 202 uses the generalized input dataset 145 and the trained state estimation model 147 to estimate one of a state in which the road surface is flat, a state in which the road surface has a level difference, and a state in which the road surface is inclined.

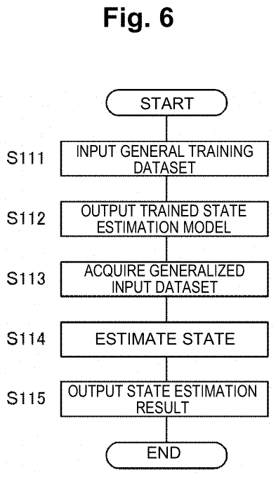

Next, FIG. 6 will be referenced to describe the action of the estimation device 20 according to the present embodiment.

FIG. 6 is a flowchart illustrating an example of a flow of processes by the estimation program according to the present embodiment. The processes by the estimation program are achieved by causing the CPU 21 of the estimation device 20 to write the estimation program stored in the ROM 22 or the storage 24 to the RAM 23 and execute the program.

In step 5111 of FIG. 6, the CPU 21 acts as the training unit 201 to receive the input of the general training dataset 142, which is a set of road surface data expressing a smooth road surface.

In step 5112, the CPU 21 acts as the training unit 201 to use the general training dataset 142 received as input in step 5111 to perform machine learning and obtain the state estimation model for training 146 for estimating the state of the road surface, and thereby outputs the trained state estimation model 147.

In step S113, the CPU 21 acts as the estimation unit 202 to acquire the generalized input dataset 145 generated by the generalized data generation device 10 described above.

In step S114, the CPU 21 acts as the estimation unit 202 to use the generalized input dataset 145 acquired in step S113 and the trained state estimation model 147 obtained by performing machine learning in step S112 to estimate the state of the road surface as one of a state in which the road surface is flat, a state in which the road surface has a level difference, and a state in which the road surface is inclined, for example.

In step S115, the CPU 21 acts as the estimation unit 202 to output the state estimation result 148 obtained by the estimation in step S114 to the storage 24 or the display unit 26 for example, and then ends the series of processes according to the estimation program.

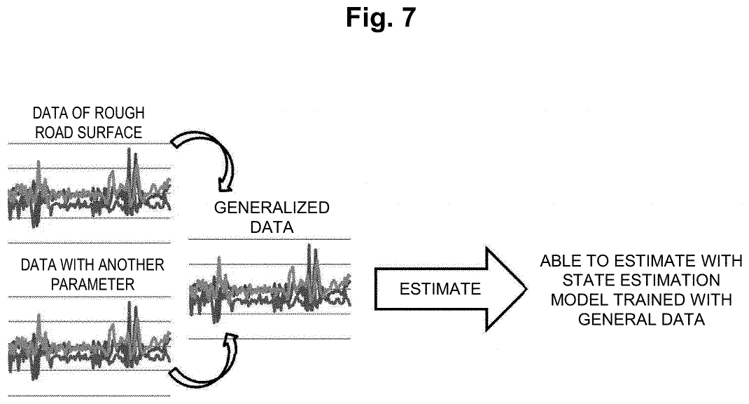

FIG. 7 is a diagram accompanying a description of the estimation process using the trained generalized model 143 and the trained state estimation model 147 according to the present embodiment.

The generalized data generation device 10 according to the present embodiment uses the trained generalized model 143 to convert road surface data with various parameters (in the example of FIG. 7, data of a rough road surface and data with another parameter) into road surface data expressing a smooth road surface (in the example of FIG. 7, generalized data). Additionally, the estimation device 20 according to the present embodiment estimates the state of the road surface by using the trained state estimation model 147 trained with general data, that is, road surface data expressing a smooth road surface with respect to the converted road surface data expressing a smooth road surface.

In this way, according to the present embodiment, it is not necessary to prepare a state estimation model suited to each of the parameters with respect to input data with various parameters, and it is sufficient to prepare only a state estimation model trained with general input data. With this arrangement, the state of a target object can be estimated accurately with the amount of training data being reduced.

Note that the generalized data generation process or the estimation process executed by causing a CPU to load software (a program) in the foregoing embodiments may also be executed by various types of processors other than a CPU. The processor in this case may be a programmable logic device (PLD) whose circuit configuration is changeable after fabrication, such as a field-programmable gate array (FPGA), or a dedicated electric circuit acting as a processor having a circuit configuration designed specifically to execute specific processes, such as an application-specific integrated circuit (ASIC), for example. Furthermore, the generalized data generation process or the estimation process may be executed by one of these various types of processors or by a combination of two or more processors of the same type or different types (such as a combination of multiple FPGAs, or a CPU and an FPGA, for example). Additionally, the hardware structure of these various types of processors is more specifically an electric circuit combining circuit elements such as semiconductor elements.

Also, the foregoing embodiments describe a mode in which the generalized data generation program or the estimation program is stored in advance (installed) in storage, but the configuration is not limited thereto. The program may also be provided by being stored on a non-transitory storage medium such as a Compact Disc-Read-Only Memory (CD-ROM), a Digital Versatile Disc-Read-Only Memory (DVD-ROM), or Universal Serial Bus (USB) memory. The program may also be configured to be downloaded from an external device over a network.

The following supplements are further disclosed with regard to the above embodiments.

(Supplement 1)

A generalized data generation device includes:

a memory; and

at least one processor connected to the memory,

wherein

the processor is configured to

train a generalized model for training for obtaining data satisfying a general parameter through predetermined machine learning by using a general training dataset as input, the general training dataset being a set of data satisfying the general parameter from among multiple types of parameters, and output a trained generalized model, and

generate a generalized input dataset generalized by using an input dataset, the input dataset being a set of data satisfying any of the multiple types of parameters, and the trained generalized model, such that the input dataset satisfies the general parameter.

(Supplement 2)

An estimation device includes:

a memory; and

at least one processor connected to the memory,

wherein

the processor is configured to

train a state estimation model for training for estimating the state of a target object through predetermined machine learning by using a general training dataset as input, the general training dataset being a set of data satisfying a general parameter from among multiple types of parameters, and output a trained state estimation model, and

estimate the state of the target object by using a generalized input dataset and the trained state estimation model, the generalized input dataset being generalized by using an input dataset, the input dataset being a set of data satisfying any of the multiple types of parameters, and a trained generalized model obtained by performing machine learning on the general training dataset, such that the input dataset satisfies the general parameter.

(Supplement 3)

A non-transitory storage medium storing a computer-executable program for executing a generalized data generation process, wherein

the generalized data generation process is configured to

train a generalized model for training for obtaining data satisfying a general parameter through predetermined machine learning by using a general training dataset as input, the general training dataset being a set of data satisfying the general parameter from among multiple types of parameters, and output a trained generalized model, and

generate a generalized input dataset generalized by using an input dataset, the input dataset being a set of data satisfying any of the multiple types of parameters, and the trained generalized model, such that the input dataset satisfies the general parameter.

(Supplement 4)

A non-transitory storage medium storing a computer-executable program for executing an estimation process, wherein

the estimation process is configured to

train a state estimation model for training for estimating the state of a target object through predetermined machine learning by using a general training dataset as input, the general training dataset being a set of data satisfying a general parameter from among multiple types of parameters, and output a trained state estimation model, and

estimate the state of the target object by using a generalized input dataset and the trained state estimation model, the generalized input dataset being generalized by using an input dataset, the input dataset being a set of data satisfying any of the multiple types of parameters, and a trained generalized model obtained by performing machine learning on the general training dataset, such that the input dataset satisfies the general parameter.

### REFERENCE SIGNS LIST

10 generalized data generation device

11, 21 CPU

12, 22 ROM

13, 23 RAM

14, 24 storage

15, 25 input unit

16, 26 display unit

17, 27 communication I/F

18, 28 bus

20 estimation device

101, 201 training unit

102 generalized data generation unit

141 generalized model for training

142 general training dataset

143 trained generalized model

144 input dataset

145 generalized input dataset

146 state estimation model for training

147 trained state estimation model

148 state estimation result

202 estimation unit

1. A generalized data generation device comprising circuitry configured to execute a method comprising:
training a generalized model for training for obtaining data satisfying a general parameter through predetermined machine learning by using a general training dataset as input, the general training dataset being a set of data satisfying the general parameter from among multiple types of parameters, and outputs a trained generalized model; and
generating a generalized input dataset generalized by using an input dataset, the input dataset being a set of data satisfying any of the multiple types of parameters, and the trained generalized model, such that the input dataset satisfies the general parameter.

2. The generalized data generation device according to claim 1, wherein
the data satisfying the general parameter is road surface data expressing a smooth road surface, and
the input dataset includes road surface data expressing a rough road surface.

3. An estimation device comprising circuitry configured to execute a method comprising:
training a state estimation model for training for estimating the state of a target object through predetermined machine learning by using a general training dataset as input, the general training dataset being a set of data satisfying a general parameter from among multiple types of parameters, and outputs a trained state estimation model; and
estimating the state of the target object by using a generalized input dataset and the trained state estimation model, the generalized input dataset being generalized by using an input dataset, the input dataset being a set of data satisfying any of the multiple types of parameters, and a trained generalized model obtained by performing machine learning on the general training dataset, such that the input dataset satisfies the general parameter.

4. The estimation device according to claim 3, wherein
the target object is a road surface, and
the circuitry further configured to execute a method comprising:
estimating one of a state in which the road surface is flat, a state in which the road surface has a level difference, and a state in which the road surface is inclined.

5. A generalized data generation method comprising:
training a generalized model for training for obtaining data satisfying a general parameter through predetermined machine learning by using a general training dataset as input, the general training dataset being a set of data satisfying the general parameter from among multiple types of parameters, and outputting a trained generalized model; and
generating a generalized input dataset generalized by using an input dataset, the input dataset being a set of data satisfying any of the multiple types of parameters, and the trained generalized model, such that the input dataset satisfies the general parameter.

6-8. (canceled)

9. The generalized data generation device according to claim 1, wherein the generalized model includes a convolutional neural network.

10. The generalized data generation device according to claim 1, wherein the generalized model includes a machine learning model.

11. The generalized data generation device according to claim 1, wherein the trained generalized model includes a model obtained by machine learning as an autoencoder, the autoencoder compressing and reconstructing road surface data expressing a smooth road surface.

12. The generalized data generation device according to claim 2, wherein the multiple types of parameters include the smooth road surface and the rough road surface.

13. The estimation device according to claim 3, wherein
the set of data satisfying the general parameter includes road surface data expressing a smooth road surface, and
the input dataset includes road surface data expressing a rough road surface.

14. The estimation device according to claim 3, wherein the state estimation model includes a convolutional neural network.

15. The estimation device according to claim 3, wherein the state estimation model includes a machine learning model.

16. The estimation device according to claim 3, wherein the generalized model includes a convolutional neural network.

17. The estimation device according to claim 3, wherein the generalized model for training includes a model obtained by machine learning as an autoencoder, the autoencoder compressing and reconstructing road surface data expressing a smooth road surface.

18. The generalized data generation method according to claim 5, wherein
the data satisfying the general parameter is road surface data expressing a smooth road surface, and
the input dataset includes road surface data expressing a rough road surface.

19. The generalized data generation method according to claim 5, wherein the generalized model includes a machine learning model.

20. The generalized data generation method according to claim 5, wherein the generalized model includes a convolutional neural network.

21. The generalized data generation method according to claim 5, wherein the trained generalized model includes a model obtained by machine learning as an autoencoder, the autoencoder compressing and reconstructing road surface data expressing a smooth road surface.

22. The estimation device according to claim 13, wherein the multiple types of parameters include the smooth road surface and the rough road surface.

23. The generalized data generation method according to claim 18, wherein the multiple types of parameters include the smooth road surface and the rough road surface.
